(19) United States
(12) Patent Application Publication
(10) Pub. No.: US 2024/0211383 A9
(43) Pub. Date: Jun. 27, 2024

(54) MACHINE LEARNING BASED METHODS AND SYSTEMS FOR GENERATING CUSTOMIZED FEEDBACK FOR PROGRAM CODES

(71) Applicant: Aidin NASIRISHARGH, San Francisco, CA (US)

(72) Inventor: Aidin NASIRISHARGH, San Francisco, CA (US)

(21) Appl. No.: 17/719,256

(22) Filed: Apr. 12, 2022

Related U.S. Application Data
(60) Provisional application No. 63/201,201, filed on Apr. 17, 2021.

(51) Int. Cl. G06F 11/36

(52) U.S. Cl. CPC G06F 11/3688; G06F 11/3664; G06F 11/3692

(57) ABSTRACT

Methods and systems machine learning-based methods and systems for generating customized feedback for program codes. The present disclosure describes a code analysis platform that facilitates code learning by generating feedback specific to a code that is submitted by a user for a problem. To use the code analysis platform to learn to code, the user may need to register first by providing user profile data on the code analysis platform. Upon registering with the code analysis platform, the user can use the code analysis platform to learn coding by writing codes for the coding problems that are displayed on a user interface provided by the code analysis platform.

### TECHNICAL FIELD

The present disclosure generally relates to computer technology and, more particularly, to machine learning-based methods and systems for generating customized feedback for program codes.

### BACKGROUND

Nowadays, computer programming is taught at schools, colleges, boot camps, as well as through online programs. In such teachings as well as during job interviews, students/applicants are often asked to write short programs for a specific task (also known as a ‘programming challenge’). The task often specifies an exact format for input to the program and expected output from that program. Such a task is often expected to be solved in a short period of time and the answer is a piece of user-submitted code that is supposed to fulfill the requirements of the task.

Since there can be numerous ways to write even a simple piece of code, it's not possible to have a verbatim comparison between one working code and the user-submitted code. Since the codes can be complicated, it would be a very tedious, time-consuming, and error-prone job for a human to read every single line of code and evaluate the submitted code manually.

Conventionally, to test the codes, either a plurality of test cases is created and provided, or documents including multiple pairs of <Given Input, Expected Output> are provided. For example, if the user is asked to write a program for sorting five numbers in increasing order, a pair of input and expected output that can be provided to test the code may include <[4, 8, 2, 5, 3], [2, 3, 4, 5, 8]>. Similarly, test cases that can be provided for testing the code submitted by the user may include different cases, such as negative numbers, big numbers, rational numbers, decimal numbers, etc., so that if the submitted code passes all these test cases (i.e., produces correct output for each input), then the submitted code can be claimed as the correct code. If the submitted code fails to produce the expected output for any of the test cases, the submitted code will be considered an incorrect code and the student/applicant may receive a message based on the evaluation. As the evaluation is done based on the code-execution, the evaluator may not know what exactly is wrong with the submitted code. Further, the message that is displayed to the user may be based on a generic feedback template that may not be very helpful for a novice user who might be interested in finding out what exactly is wrong with the submitted code.

For novice users who are just practicing or students who are just starting up and have not built the skill set to debug the code on their own, such generic feedback can be very frustrating. Further, when code learners (i.e., users) are stuck on a piece of code that doesn't work as expected, they spend hours trying to seek help from a mentor or post their codes in online forums hoping that someone will leave them feedback that may help them in deciding the next step be followed to correct the code. Both cases can be very time-consuming and frustrating.

In view of the above, there is a need for a technological solution for analyzing the code to find out what exactly is wrong with the codes and for providing human-level feedback to the users that may help the users in taking the next step to correct the codes.

### SUMMARY

Various embodiments disclose machine learning-based methods and systems for generating customized feedback for program codes.

In an embodiment, a method is comprising a code analysis platform incorporated in a server system disclosed. The method includes receiving, a written code for a coding problem from a user device submitted by a user, performing an analysis of the code by running the submitted code against at least one test case that is stored for the corresponding coding problem and displaying, a successful message when the submitted code seems to be working fine for all the test cases or an evaluation response when the submitted code does not clear all the test cases respectively. The method further includes performing, fingerprint extraction of the submitted code, wherein the fingerprint extraction includes a structural code fingerprint extraction in which a structural fingerprint of the code is extracted, and a behavioral code fingerprint extraction in which a behavioral fingerprint of the code is extracted, generating, a formed CDNA by combining the extracted structural fingerprint and the behavioral fingerprint, determining, by the server system one or more CDNAs stored for the corresponding coding problem of the submitted code, comparing, the formed CDNA with each determined CDNA to compute a similarity score for each determined CDNA and selecting, one or more CDNAs from the determined CDNAs based on a predefined threshold score set for the similarity score and collecting, one or more feedbacks associated with the selected CDNAs, and displaying, one or more feedbacks on the user device.

In another embodiment, a server system is disclosed. The server system, includes a memory configured to store instructions, and a processor configured to execute the instructions stored in the memory and thereby cause the server system to perform: receive a written code for a coding problem from a user device submitted by a user, perform an analysis of the code by running the submitted code against at least one test case that is stored for the corresponding coding problem, and display a successful message when the submitted code seems to be working fine for all the test cases or an evaluation response when the submitted code does not clear all the test cases respectively. The server system is further configured to perform fingerprint extraction of the submitted code, wherein the fingerprint extraction includes a structural code fingerprint extraction in which a structural fingerprint of the code is extracted, and a behavioral code fingerprint extraction in which a behavioral fingerprint of the code is extracted, generate, a formed CDNA by combining the extracted structural fingerprint and the behavioral fingerprint, determine, one or more CDNAs stored for the corresponding coding problem of the submitted code, compare the formed CDNA with each determined CDNA to compute a similarity score for each determined CDNA and select, one or more CDNAs from the determined CDNAs based on a predefined threshold score set for the similarity score. The server system is further configured to collect one or more feedbacks associated with the selected CDNAs and display one or more feedbacks on the user device.

In yet another embodiment, a system is disclosed. The system includes a memory configured to store instructions, a communication interface, and a processor in communication with the memory and the communication interface, the processor configured to execute the instructions stored in the memory and further comprising a fingerprint extraction module configured to extract one or more structural and behavioral fingerprints of a submitted code for creating at least one formed CDNA associated with the submitted code of the user, a similarity score computation module configured to determine one or more CDNAs stored for the corresponding coding problem and generate a score list describing each determined CDNA with their calculated similarity score by computing a similarity score between each determined CDNAs and the formed CDNA associated with the submitted code, a feedback selection module configured to select one or more feedbacks from a plurality feedbacks stored for the at least one determined CDNAs whose similarity score is found to be greater than the predefined threshold score or add the submitted code to a pending feedback queue when the similarity score of determined CDNAs does not meet the predefined threshold criteria, and a notification management module configured to control the notification messages that are to be sent to a user and an administrator sent to the user device and administrator device respectively.

### BRIEF DESCRIPTION OF THE FIGURES

For a more complete understanding of example embodiments of the present technology, reference is now made to the following descriptions taken in connection with the accompanying drawings in which:

FIG. 1 illustrates an environment related to at least some example embodiments of the present disclosure;

FIG. 2 illustrates a block diagram of a server system, in accordance with example embodiments of the present disclosure;

FIG. 3 is a flow diagram of a process followed for evaluating a submitted code, in accordance with exemplary embodiments of the present disclosure;

FIG. 4A is a flow diagram of a process followed for performing analysis of a submitted code for generating feedback for the submitted code, in accordance with example embodiments of the present disclosure;

FIG. 4B is a flow diagram of a process followed for adding an administrator's feedback for a submitted code, in accordance with example embodiments of the present disclosure;

FIG. 5A is an example representation of a User Interface (UI) displaying a code submission page on a user device of a user for submitting a code written by the user for a coding problem, in accordance with an example embodiment of the present disclosure;

FIG. 5B is an example representation of a UI displaying a feedback page, in accordance with an example embodiment of the present disclosure;

FIG. 6 is a flow diagram of steps performed by the code analysis platform that facilitates code learning by generating feedback specific to a code that is submitted by a user for a problem, in accordance with an example embodiment; and

FIG. 7 is a simplified block diagram of an electronic device capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality and without imposing limitations upon, the present disclosure.

### OVERVIEW

Various embodiments disclose machine learning-based methods and systems for generating customized feedback for program codes.

In various example embodiments, the present disclosure describes a code analysis platform that facilitates code learning by generating feedback specific to a code that is submitted by a user for a problem. To use the code analysis platform to learn to code, the user may need to register first by providing user profile data on the code analysis platform. Upon registering with the code analysis platform, the user can use the code analysis platform to learn coding by writing codes for preloaded coding problems that are displayed on a user interface provided by the code analysis platform.

The present disclosure provides a server associated with the code analysis platform. The server receives the written code submitted by the user for a coding problem on the code analysis platform, and the server performs an analysis of the code so that feedback relevant to the submitted code can be generated.

At first, upon receiving the submitted code, the server performs an analysis of the code by running the code against the test cases that are stored for the corresponding coding problem. In an embodiment, if the submitted code seems to be working fine for all the test cases, the server returns a successful message that is displayed to the user on his/her user device. Further, if the submitted code does not clear all the test cases, the server performs fingerprint extraction of the submitted code. In an embodiment, the fingerprint extraction includes 1) a structural code fingerprint extraction in which a structural fingerprint of the code is extracted, and 2) a behavioral code fingerprint extraction in which a behavioral fingerprint of the code is extracted. The extracted structural fingerprint and the behavioral fingerprint of the code together form a DNA of the code (also referred to as “CDNA”). Once the CDNA is formed (also referred to as “formed CDNA”), the server determines the CDNAs that are already stored for the corresponding coding problem for which the code is submitted. Thereafter, the server is configured to compare the formed CDNA with each determined CDNA to compute a similarity score for each determined CDNA.

Once the similarity score for each determined CDNA is available, the server is configured to select one or more CDNAs from the determined CDNAs based on a predefined threshold score set for the similarity score. Further, the server is configured to collect one or more feedbacks associated with the selected CDNAs. The collected one or more feedbacks are then presented on the user device. The presented feedback may help the user in identifying problematic areas of the submitted code that further helps the user in making changes to the code and subsequently correct the code.

Various example embodiments offer, among other benefits, techniques for establishing machine learning-based methods and systems for generating customized feedback for program codes. The system generates feedback that is specific to the submitted code, thereby saving the user time that goes into debugging the code. The system uses machine learning-based models for generating feedbacks for the codes, thereby eliminating the need of adding manual feedback for the code while ensuring better feedback over the period of time.

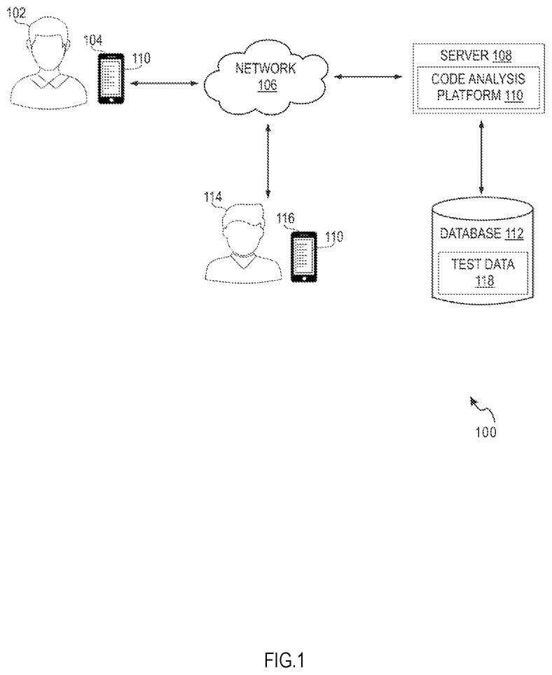

FIG. 1 is an illustration of an environment 100 related to at least some example embodiments of the present disclosure. Although the environment 100 is presented in one arrangement, other embodiments may include the parts of the environment 100 (or other parts) arranged otherwise depending on, for example, providing customized feedback for a submitted code, etc. The environment 100 includes, but is not limited to a wireless communication network (e.g. a network 106) that connects entities such as a user 102, an administrator 114, and a server 108.

The network 106 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 106 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof.

The user 102 is depicted to be associated with an electronic device 104 (hereinafter referred to as ‘user device 104’). Similarly, the administrator 114 is depicted to be associated with an electronic device 116 (hereinafter referred to as ‘administrator device 116’). It should be noted that one user and one administrator are shown for the sake of simplicity, there can be more users and administrators.

In an embodiment, the user device 104 is equipped with a code analysis platform 110 that analyzes a program code and provides customized feedback to a user (e.g. the user 102) for the program code in case the program code is not working in an expected manner. The user device 104 and the administrator device 116 may be any communication device having hardware components for enabling User Interfaces (UIs) of the code analysis platform 110 to be presented on the user device 104 and the administrator device 116, respectively. The user device 104 and the administrator device 116 may be capable of being connected to a wireless communication network (such as the network 106). Examples of the user device 104 and the administrator device 116 include a mobile phone, a smart telephone, a computer, a laptop, a PDA (Personal Digital Assistant), a Mobile Internet Device (MID), a tablet computer, an Ultra-Mobile personal computer (UMPC), a phablet computer, a handheld personal computer and the like.

In one embodiment, the user 102 can access the code analysis platform 110 through a web browser or a mobile application installed on the user device 104. Similarly, the administrator 114 can also access the code analysis platform 110 through the web browser or the mobile application installed on the administrator device 116.

In one example embodiment, the user 102 may access the code analysis platform 110 for providing user profile data to create a user profile for using the code analysis platform 110. The user profile data may include username, contact information, age, occupation, coding purpose, etc. The user 102 may also access the code analysis platform 110 for learning to code. In an embodiment, for facilitating code learning, the user 102 may be asked to submit codes for some basic to advanced level preloaded coding problems by the code analysis platform 110. The codes submitted by the user 102 for one or more preloaded coding problems may then be analyzed by the code analysis platform 110 to generate an evaluation response for each submitted code. In an embodiment, the submitted code for a specific coding problem is evaluated based on test data 118 stored in a database 112 for the problem for which the code is submitted.

In at least one example embodiment, the evaluation response of the submitted code may include an evaluation result, result details, and one or more feedbacks. In an embodiment, the evaluation result notifies the user 102 about the correctness of the code (i.e., whether the submitted code is passed or not.) The result details may include information about errors, such as memory limit errors, run time errors, syntax errors etc., that may have occurred while running the code. For example, if the submitted code is found to be taking more memory than the maximum allowed memory, the result details may show ‘Memory limit error’. The feedbacks may provide more detailed information about the problematic areas of the code that may further help the user 102 in fixing their incorrect code in case the submitted code is found to be incorrect (i.e. not working as expected.) For example, the user 102 may submit a program (i.e., code) for finding the smallest number in an array. The result of the analysis of the program by the code analysis platform 110 depicts that the program is working fine for all positive numbers arrays but in the case of the negative numbers, the results are incorrect. So, an example of the feedback that may be provided by the code analysis platform 110 can be “Have you considered negative numbers?”. The received feedback may help the user 102 in identifying a problematic area of the code (e.g. consideration of negative numbers.) Based on the received feedback, the user 102 may try to update the code in such a way that it works for both the positive and negative numbers.

In an embodiment, the server 108 may reside software backend APIs corresponding to the code analysis platform 110 which instructs the server 108 to perform one or more operations described herein. In addition, the server 108 should be understood to be embodied in at least one computing device in communication with the network 106, which may be specifically configured, via executable instructions, to perform as described herein, and/or embodied in at least one non-transitory computer-readable media.

The code analysis platform 110 is an application/tool resting at the server 108. In one embodiment, the server 108 is configured to host and manage the code analysis platform 110 and communicate with the electronic devices, such as the user device 104 and the administrator device 116 for providing an instance of the code analysis platform 110.

In one embodiment, the server 108 is configured to receive a request to check/analyze the code submitted by a user (e.g., the user 102) for a coding problem from the user device 104 via the network 106. The server 108 is then configured to perform fingerprint extraction of the submitted code. In an embodiment, the fingerprint extraction includes a structural code fingerprint extraction in which a structural fingerprint of the code is extracted and a behavioral code fingerprint extraction in which a behavioral fingerprint of the code is extracted. In structural code fingerprint extraction, a cyclomatic complexity, or a number of functions, or a number of arguments in each function of the submitted code is determined. The behavioral code fingerprint extraction includes testing the code with respect to the stored test data to determine the correctness of the code. The behavioral fingerprint of the code may include results of the testing of the code against the test data, such as the number of tests passed, number of tests failed, outputs of the failed tests, etc. The structural fingerprint and the behavioral fingerprint of the code together form the DNA of the code (also referred to as “Code DNA” or “CDNA”). The CDNA generated for a submitted code is hereinafter referred to as “formed CDNA” interchangeably, throughout the specification.

Once the formed CDNA of the submitted code is available, the server 108 is configured to determine the CDNAs that are stored for the same coding problem in the database 112. It should be noted that the CDNAs that have at least one feedback associated with them in the database 112 are determined by the server 108. The server 108 is then configured to compare the formed CDNA of the submitted code with each determined CDNA to compute a similarity score for each determined CDNA. In an embodiment, the similarity score represents how similar two CDNAs are. The similarity score value of ‘1’ means the formed CDNA of the submitted code and the determined CDNA are completely identical and a value of ‘0’ means the CDNA's are completely irrelevant.

Further, the server 108 is configured to select one or more CDNAs from the determined CDNAs based on the similarity score of each determined CDNA. The server 108 may select a determined CDNA only if the similarity score of the respective CDNA is found to be higher than a predefined threshold score. In an embodiment, the predefined threshold score may be set by an administrator (e. g. , the administrator 114) of the code analysis platform 110.

Thereafter, the server 108 is configured to collect one or more feedbacks that are associated with the selected CDNAs. The collected feedbacks are then displayed on a user interface (UI) facilitated by the code analysis platform 110 on the user device 104.

However, in other embodiments, where the similarity score of determined CDNAs does not meet the predefined threshold criteria, the server 108 may add the submitted code to a pending feedback queue maintained by the server 108. In case the code is added to the pending feedback queue, the user 108 may not receive an immediate feedback from the code analysis platform 110.

In one embodiment, the server 108 may send a notification regarding the submitted code being added in the pending feedback queue to the administrator 114 of the code analysis platform 110. The administrator 114, upon receiving the notification on the administrator device 116, may check the submitted code and add a customized feedback for the submitted code indicating the problematic areas of the submitted code. The customized feedback added for the submitted code is then displayed to the user 102 on the user device 104. In an embodiment, the user 102 may receive a notification regarding the addition of the feedback for the submitted code. The customized feedback is further stored by the server 108 in the database 112 along with the formed CDNA of the submitted code.

In an embodiment, the server 108 may utilize one or more machine learning models that may detect the determined CDNAs whose similarity score is matching with the formed CDNA of the submitted code to determine the similar types of codes. The machine learning models may then generate the feedback for the submitted code by reusing the existing one or more feedbacks that are available for similar codes on the same coding problem. In an embodiment, the feedbacks on the same coding problem may either be customized feedbacks submitted by users (such as, the user 102) or by administrators (such as, the administrator 114) of the code analysis platform 110. It should be noted that the server 108 analyzes the customized feedbacks submitted by users/administrators before storing the customized feedbacks in the database 112 for the coding problem. In one example, if the user submits the code for checking a palindrome number, a machine learning model detects the codes that are submitted for checking the palindrome numbers. Further, the CDNAs of the detected codes are extracted and the feedbacks associated with the extracted CDNAs are then utilized by the machine learning model to generate the feedback for the submitted code.

It is noted that the instructions (or the executable code) configuring the code analysis platform 110 are stored in a memory of the server 108 and the instructions are executed by a processor (for example, a single-core or a multi-core processor) included within the server 108. Accordingly, even though the various functionalities for generating customized feedback for program codes are explained with reference to or being performed by the code analysis platform 110, it is understood that the processor in conjunction with the code in the memory is configured to execute the various tasks as enabled by the instructions of the code analysis platform 110.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of the environment 100 may perform one or more functions described as being performed by another set of systems or another set of devices of the environment 100.

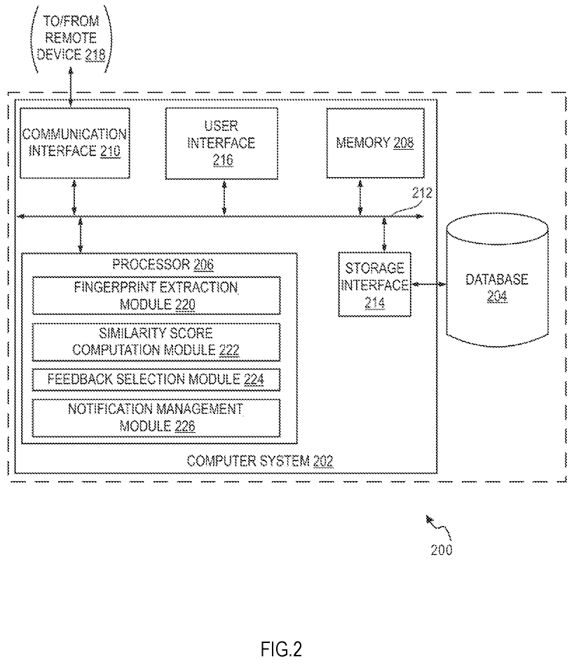

Various embodiments of the present description are explained with reference to FIGS. 2 to 6.

FIG. 2 is a block diagram of a server system 200, in accordance with an example embodiment. In some embodiments, the server system 200 is embodied as a cloud-based and/or SaaS-based (software as a service) architecture. The server system 200 is an example of the server 108 explained with reference to FIG.1. The server system 200 is configured to perform analysis of the program code and to generate feedback that is specific to the submitted code. In an embodiment, the server system 200 includes a computer system 202 and a database 204. The computer system 202 further includes at least one processor 206 for executing instructions, a memory 208, a communication interface 210, and a user interface 216 that communicate with each other via a bus 212.

In some embodiments, the database 204 is integrated within computer system 202. For example, the computer system 202 may include one or more hard disk drives as the database 204. A storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

In one embodiment, the database 204 is configured to store profile data associated with each user of the one or more users, such as the user 102 and the administrator 114. The database 204 is also configured to store test data associated with each preloaded coding problem for which the code is to be written by the user, such as the user 102. Further, the database 204 is configured to store CDNA associated with the codes submitted for each coding problem. Additionally, the database 204 is configured to store one or more feedbacks that are provided for each submitted code.

The processor 206 includes suitable logic, circuitry, and/or interfaces to execute operations for receiving a request from a user (e.g., the user 102) for checking the submitted code. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208, as described herein. In another embodiment, the memory 208 may be realized in the form of a database server or cloud storage, without departing from the scope of the present disclosure.

The processor 206 is operatively coupled to the communication interface 210 such that the processor 206 is capable of communicating with the remote device 218 such as, the user device 102, the administrator device 116, or communicating with any entity connected to the network 106 (as shown in FIG. 1). Further, the processor 206 is operatively coupled to the user interface 216 for interacting with the user 102.

It is noted that the server system 200 as illustrated and hereinafter described is merely illustrative of an apparatus that could benefit from embodiments of the present disclosure and, therefore, should not be taken to limit the scope of the present disclosure. It is noted that the server system may include fewer or more components than those depicted in FIG. 2.

The processor 206 includes a fingerprint extraction module 220, a similarity score computation module 222, a feedback selection module 224, and a notification management module 226. It should be noted that components, described herein, can be configured in a variety of ways, including electronic circuitries, digital arithmetic and logic blocks, and memory systems in combination with software, firmware, and embedded technologies.

In one embodiment, the processor 206 is configured to receive a request for checking the code submitted by the user 102 for a coding problem.

The fingerprint extraction module 220 includes suitable logic, circuitry, and/or interfaces to execute computer-readable instructions for extracting all the structural and behavioral fingerprints of the submitted code that may further help in creating the CDNA of the code submitted for the problem. The fingerprint extraction module 220 is configured to generate formed CNDAs associated with the submitted code of the user.

The similarity score computation module 222 is in communication with the fingerprint extraction module 220. The similarity score computation module 222 includes suitable logic, circuitry, and/or interfaces to execute computer-readable instructions for determining the CDNAs that are stored for the corresponding coding problem. The similarity score computation module 222 is further configured to determine a similarity score between each determined CDNAs and the formed CDNA associated with the submitted code. Thereafter, the similarity score computation module 222 is configured to generate a score list describing each determined CDNA with their calculated similarity score.

The feedback selection module 224 is in communication with the similarity score computation module 222. The feedback selection module 224 includes suitable logic, circuitry, and/or interfaces to execute computer-readable instructions for checking the score list provided by the similarity score computation module 222 and determining the CDNAs whose similarity score is greater than a predefined threshold score. If no similarity score is found to be greater than the predefined threshold score, the feedback selection module 224 is configured to add the code in a pending queue.

The feedback selection module 224 is then configured to select one or more feedbacks from the feedbacks that are stored for the determined CDNAs whose similarity score is found to be greater than the predefined threshold score. The selected one or more feedbacks are then displayed by the processor 206 on the user interface 216.

The notification management module 226 includes suitable logic, circuitry, and/or interfaces to execute computer-readable instructions for controlling notification messages that are to be sent to the user 102 and the administrator 114. In one embodiment, the notification management module 226 is configured to send a notification message to the administrator device 116 to inform the administrator 114 about the addition of the code in the pending queue. The notification management module 226 is also configured to send a notification on the user device 104 to inform the user 102 about the availability of the feedback for the submitted code.

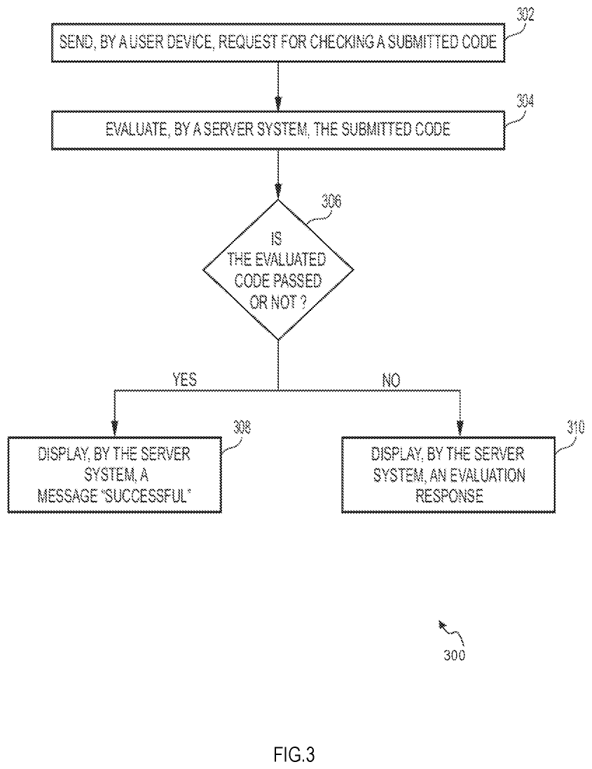

FIG. 3 is a flow diagram 300 of a process followed for evaluating a submitted code, in accordance with an example embodiment of the present disclosure. The steps of the flow diagram 300 may not be necessarily executed in the same order as they are presented. Further, one or more steps may be grouped and performed in form of a single step, or one step may have several sub-steps that may be performed in parallel or in a sequential manner.

At 302, a user device (e.g., the user device 104) sends a request for checking a code (hereinafter referred to as “submitted code”) submitted by a user (e.g., the user 102) for a coding problem.

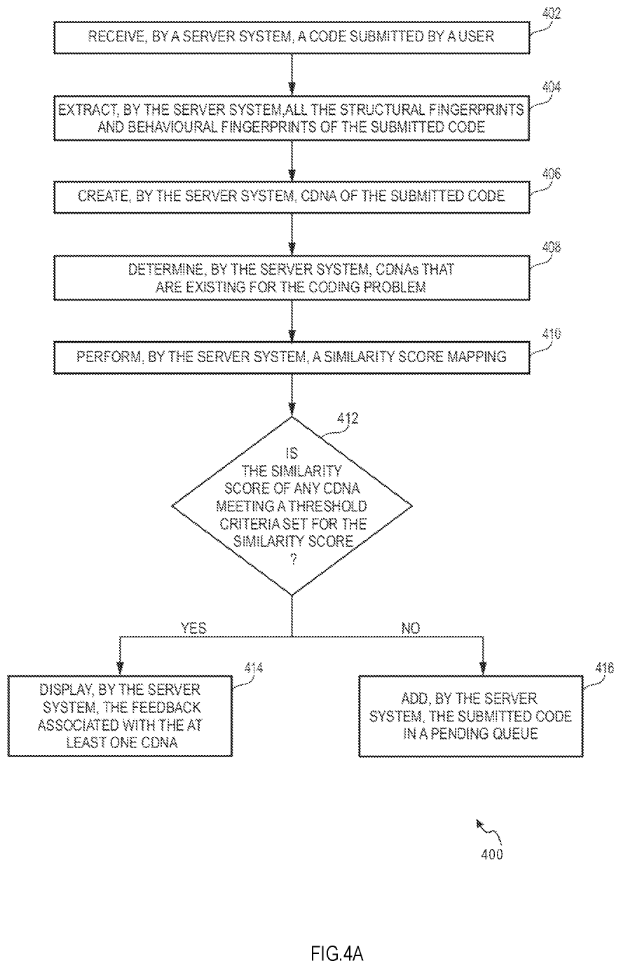

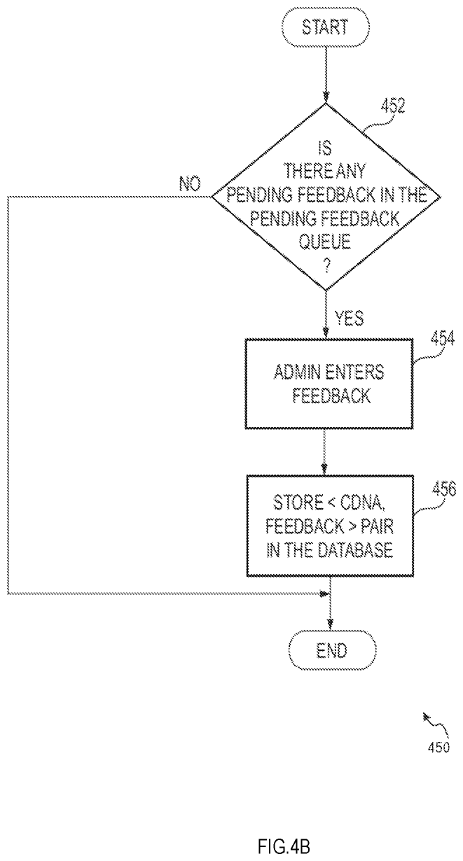

At 304, the server system 200, upon receiving the request, evaluates the submitted code for the coding problem. The server system 200 may use environmental limits and the test data stored in a database (e.g. the database 204) for the problem for evaluating the submitted code. In some embodiments, the server system 200, upon receiving the request, may send the environmental limits and the test data stored for the problem to the user device 104. Further, the user device 104, upon receiving the environmental limits and the test data from the server system 200, may test the submitted code against the received environmental limits and one or more test cases included in the received test data to generate a testing result for the submitted code. Once the testing result is generated for the submitted code, the user device 104 may send the testing result along with the submitted code to the server system 200 for performing evaluation of the submitted code. The process followed by the server system 200 for evaluation is explained in detail with reference to FIGS. 4A and 4B.

At 306, the server system 200 checks whether the evaluated code is passed or not. In some embodiments, the server system 200 may go through the testing result provided by the user device 104 to check whether the evaluated code is passed or not. If the evaluated code is found to be passed, a message about successful passing of the submitted code is displayed on the user device 104 (see, 308), otherwise, evaluation response is presented on the user device 104 (see, 310). The evaluation response of the submitted code may include an evaluation result, result details, and one or more feedbacks for the submitted code.

FIG. 4A is a flow diagram 400 of a process followed for performing analysis of a submitted code for generating feedback for the submitted code, in accordance with an example embodiment of the present disclosure. The steps of the flow diagram 400 may not be necessarily executed in the same order as they are presented. Further, one or more steps may be grouped and performed in form of a single step, or one step may have several sub-steps that may be performed in parallel or in a sequential manner.

As mentioned above, the user 102 may perform registration on the code analysis platform 110 by providing user profile data in order to learn coding. Once the registration is done, the user 102 may write and submit a code (also referred to as “submitted code”) for a preloaded coding problem using a user interface provided by the code analysis platform 110. The code submitted for the problem is then analyzed by the server system 200 to generate one or more feedback that is specific to the submitted code.

At 402, the server system 200 receives the code submitted by the user 102 using the user interface facilitated by the code analysis platform 110. At 404, the server system 200 extract all the structural fingerprints and behavioral fingerprints of the submitted code.

At 406, the server system 200 creates code DNA (i.e., CDNA) of the submitted code based on the extracted structural and behavioral fingerprints of the submitted code.

At 408, the server system 200 determines CDNAs that are existing for the coding problem. In an embodiment, the CDNAs that have at least one feedback associated with them are considered by the server system 200. At 410, the server system 200 performs a similarity score mapping by computing the similarity score for each of the determined CDNAs and the formed CDNA associated with the submitted code.

At 412, the server system 200 checks whether the similarity score of any determined CDNA is meeting the threshold criteria set for the similarity score (i.e. the similarity score is greater than the predefined threshold score.) If the similarity score of at least one CDNA is found to be meeting the threshold criteria, then the step 414 is performed, else the step 416 is performed.

At 414, the server system 200 selects and displays the feedback associated with the at least one determined CDNA. At 416, the server system 200 adds the submitted code in a pending queue maintained by the server system 200. A process followed for the submitted code after the addition of the submitted code in the pending queue is explained in detail with reference to FIG. 4B.

FIG. 4B is a flow diagram 450 of a process followed for adding an admin feedback for a code, in accordance with an example embodiment of the present disclosure. The steps of the flow diagram 450 may not to be necessarily executed in the same order as they are presented. Further, one or more steps may be grouped and performed in form of a single step, or one step may have several sub-steps that may be performed in parallel or in a sequential manner.

As mentioned above, the submitted code may be added to a pending feedback queue in case no relevant feedback is found for the formed CDNA associated with the submitted code. Once an administrator (e.g., the administrator 114) logs in to the code analysis platform 110 using an administrator device (e.g., the administrator device 116), the administrator can check one or more CDNAs associated with submitted codes, for which the feedback is yet to be given in the code analysis platform 110.

At 452, the administrator 114, using the code analysis platform 110 installed on the administrator device 116, checks whether there is any pending feedback in the pending feedback queue. If there is a submitted code in the pending feedback queue, the method proceeds to 454, else the method terminates.

At 454, the administrator 114 enters the feedback for the submitted code by manually examining the submitted code.

At 456, the server system 200 stores the feedback along with the CDNA of the submitted code. In an embodiment, a <CDNA, feedback> pair is created for each submitted code and then the <CDNA, feedback> pair is stored in a database (e.g., the database 112/the database 204).

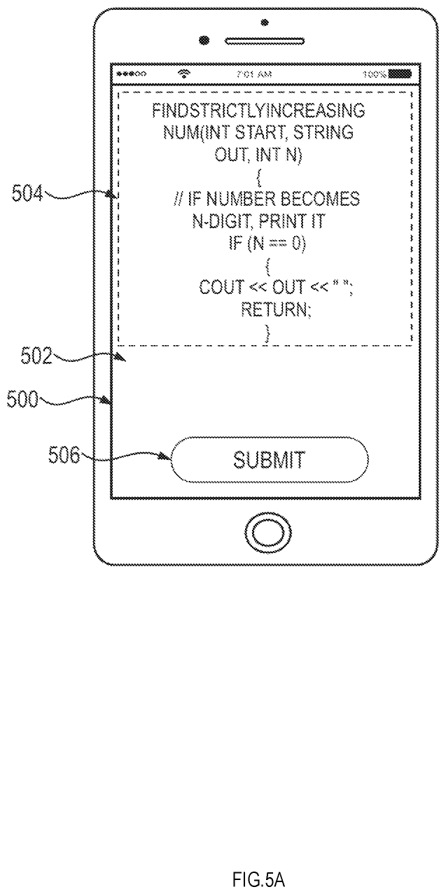

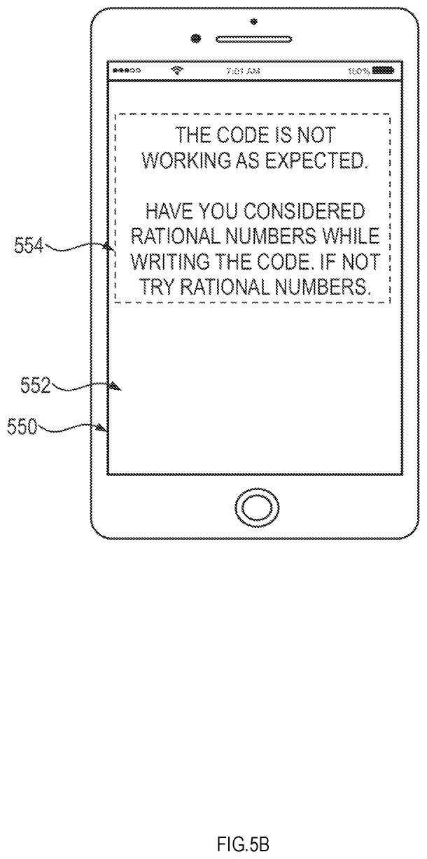

FIG. 5A shows an example representation of a User Interface (UI) 500 displaying a code submission page 502 on a user device (e.g., the user device 104) of a user (e.g., the user 102) for submitting a code written by the user for a coding problem, in accordance with an example embodiment of the present disclosure. The UI 500 is presented to the user 102 who wants to learn coding by receiving feedback specific to the submitted code.

The code submission page 502 includes a code section 504 where the user 102 can write the code for a specific coding problem. The code submission page 502 also includes a submit button 506 that can be clicked by the user 102 for submitting the code written in the code section 504. Once the user 102 clicks the submit button 506, the code is submitted for code evaluation that may be performed either partially by the server system 200 and partially by the user device 104 or completely by the server system 200 as explained with reference to FIGS. 3 and 4A.

FIG. 5B shows an example representation of a UI 550 displaying a feedback page 552 on a user device (e.g., the user device 104) of a user (e.g., the user 102), in accordance with an example embodiment of the present disclosure. The UI 550 is presented to the user 102 who has submitted the code for a coding problem.

The feedback page 552 includes a feedback section 554 where the feedback generated for the submitted code is displayed. The displayed feedback can then be used by the user 102 to correct the submitted code in case the submitted code is found to be problematic.

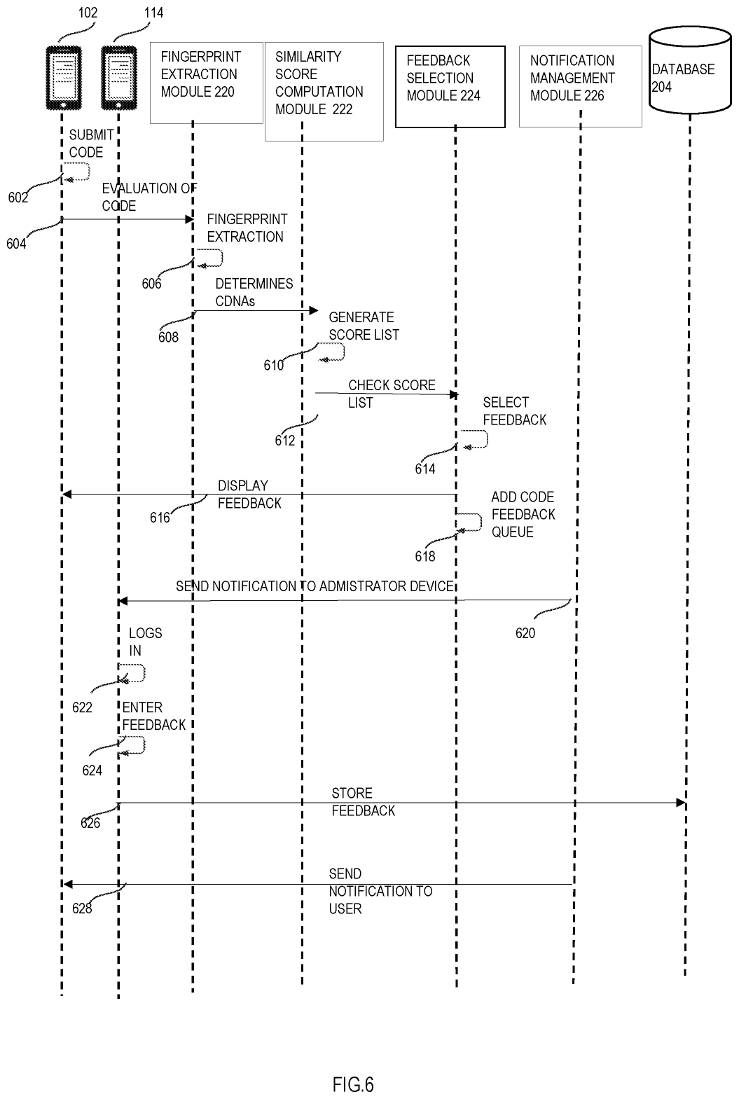

FIG. 6 is a flow diagram 600 performed by the code analysis platform that facilitates code learning by generating feedback specific to a code that is submitted by a user for a problem, in accordance with an example embodiment. The operations of the flow diagram 600 may be carried out by a server such as the server 108, the system 200 or the user device 104. The sequence of operations of the flow diagram 600 may not be necessarily executed in the same order as they are presented. Further, one or more operations may be grouped and performed in form of a single step, or one operation may have several sub-steps that may be performed in parallel or in a sequential manner.

At operation 602, a user (e.g., the user 102) may use the code analysis platform 110 installed on a user device (e.g., the user device 104) for submitting a code for a coding problem.

At operation 604, the code analysis platform 110, upon receiving the submitted code, may perform an evaluation of the submitted code to check whether the evaluated code passes all the test cases for the coding problem or generates an evaluation response with an evaluation result, result details, and one or more feedbacks for the submitted code. The process of generating an evaluation response is explained in the following steps 606-628.

At operation 606, the fingerprint extraction module 220 extracts all the structural fingerprints and behavioral fingerprints of the submitted code and creates at least one code DNA (i.e., CDNA) of the submitted code based on the extracted structural and behavioral fingerprints of the submitted code.

At operation 608, the similarity score computation module 222 determines CDNAs that are existing for the coding problem. In an embodiment, the CDNAs that have at least one feedback associated with them and computes between each determined CDNAs and the formed CDNA associated with the submitted code.

At operation 610, the similarity score computation module 222 generates a similarity score mapping or score list describing each determined CDNA with their calculated similarity score.

At operation 612, the feedback selection module 224 is then configured for checking the score list provided by the similarity score computation module 222 and determining the CDNAs whose similarity score is greater than a predefined threshold score then the steps 614-616 are performed, else the steps 618-620 are performed.

At operation 614, the feedback selection module 224 is then configured to select one or more feedbacks from the feedbacks that are stored for the determined CDNAs whose similarity score is found to be greater than the predefined threshold score.

At operation 616, the code analysis platform 110 displays the selected one or more feedbacks on the user device 104.

At operation 618, the feedback selection module 224 is configured to add the code in a pending queue if no similarity score is found to be greater than the predefined threshold score for the determined CDNAs.

At operation 620, the notification management module 226 is configured to send a notification message to the administrator device 116 to inform the administrator 114 about the addition of the code in the pending queue.

At operation 622, the administrator 114 logs in to the code analysis platform 110 using an administrator device (e.g., the administrator device 116), checks whether there is any pending feedback in the pending feedback queue. If there is a submitted code in the pending feedback queue, the method proceeds to 624, else the method terminates.

At operation 624, the administrator 114 can check one or more CDNAs associated with submitted codes, for which the feedback is yet to be given in the code analysis platform 110 and enters the feedback for the submitted code by manually examining the submitted code.

At operation 626, the code analysis platform 110 stores the feedback along with the CDNA of the submitted code in a database 204

At operation 628, the notification management module 226 is configured to send a notification on the user device 104 to inform the user 102 about the availability of the feedback for the submitted code.

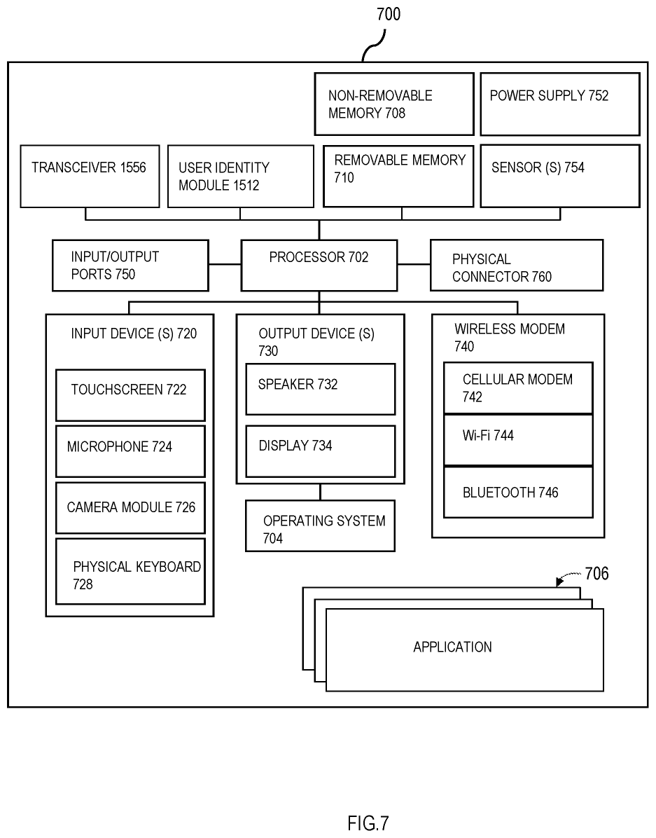

FIG. 7 shows a simplified block diagram of an electronic device 700 capable of implementing the various embodiments of the present disclosure. The electronic device 700 may be an example of the user device 104 or the administrator device 116. It should be understood that the electronic device 700 as illustrated and hereinafter described is merely illustrative of one type of device and should not be taken to limit the scope of the embodiments. As such, it should be appreciated that at least some of the components described below in connection with the electronic device 700 may be optional and thus in an example embodiment may include more, less, or different components than those described in connection with the example embodiment of the FIG. 7. As such, among other examples, the electronic device 700 could be any of an electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 700 includes a controller or a processor 702 (e.g., a signal processor, microprocessor, ASIC, or other control and processing logic circuitry) for performing such tasks as signal coding, data processing, image processing, input/output processing, power control, and/or other functions. An operating system 704 controls the allocation and usage of the components of the electronic device 700 and provides support for one or more programs such as a code analysis platform that implements one or more of the innovative features described herein. The electronic device 700 is depicted to include one or more applications such as the code analysis platform 706 facilitated by the server system 200/the server 108. The code analysis platform 706 can be an instance of an application downloaded from the server system 200/the server 108 or a third-party server. The code analysis platform 706 is capable of communicating with the server system 200/the server 108 for sending codes submitted by a user (e.g., user 102) and receiving feedbacks from the server system 200/the server 108. The applications may further include common mobile computing applications (e.g., telephony applications, email applications, calendars, contact managers, web browsers, messaging applications such as USSD messaging or SMS messaging or SIM Tool Kit (STK) application) or any other computing application.

The illustrated electronic device 700 includes one or more memory components, for example, a non-removable memory 708 and/or a removable memory 710. The non-removable memory 708 and/or the removable memory 710 may be collectively known as storage device/module in an embodiment. The non-removable memory 708 can include RAM, ROM, flash memory, a hard disk, or other well-known memory storage technologies. The removable memory 710 can include flash memory, smart cards, or a Subscriber Identity Module (SIM). The one or more memory components can be used for storing data and/or code for running the operating system 704. The electronic device 700 may further include a user identity module (UIM) 712. The UIM 712 may be a memory device having a processor built-in. The UIM 712 may include, for example, a subscriber identity module (SIM), a universal integrated circuit card (UICC), a universal subscriber identity module (USIM), a removable user identity module (R-UIM), or any other smart card. The UIM 712 typically stores information elements related to a mobile subscriber. The UIM 712 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 700 can support one or more input devices 720 and one or more output devices 730. Examples of the input devices 720 may include, but are not limited to, a touch screen/a display screen 722 (e.g., capable of capturing finger tap inputs, finger gesture inputs, multi-finger tap inputs, multi-finger gesture inputs, or keystroke inputs from a virtual keyboard or keypad), a microphone 724 (e.g., capable of capturing voice input), a camera module 726 (e.g., capable of capturing still picture images and/or video images) and a physical keyboard 728. Examples of the output devices 730 may include, but are not limited, to a speaker 732 and a display 734. Other possible output devices can include piezoelectric or other haptic output devices. Some devices can serve more than one input/output function. For example, the touch screen 722 and the display 734 can be combined into a single input/output device.

A wireless modem 740 can be coupled to one or more antennas (not shown in the FIG. 7) and can support two-way communications between the processor 702 and external devices, as is well understood in the art. The wireless modem 740 is shown generically and can include, for example, a cellular modem 742 for communicating at long range with the mobile communication network, a Wi-Fi compatible modem 744 for communicating at short range with an external Bluetooth-equipped device or a local wireless data network or router, and/or a Bluetooth-compatible modem 746. The wireless modem 740 is typically configured for communication with one or more cellular networks, such as a GSM network for data and voice communications within a single cellular network, between cellular networks, or between the electronic device 700 and a public switched telephone network (PSTN).

The electronic device 700 can further include one or more input/output ports 750, a power supply 752, one or more sensors 754 for example, an accelerometer, a gyroscope, a compass, a global positioning system sensor (for providing location details) or an infrared proximity sensor for detecting the orientation or motion of the electronic device 700, a transceiver 756 (for wirelessly transmitting analog or digital signals) and/or a physical connector 760, which can be a USB port, IEEE 1294 (FireWire) port, and/or RS-232 port. The illustrated components are not required or all-inclusive, as any of the components shown can be deleted and other components can be added.

The present disclosure is described above with reference to block diagrams and flowchart illustrations of method and system embodying the present disclosure. It will be understood that various blocks of the block diagram and flowchart illustrations, and combinations of blocks in the block diagrams and flowchart illustrations, respectively, may be implemented by a set of computer program instructions. These set of instructions may be loaded onto a general-purpose computer, special-purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware, and software as described herein may also be employed.

Various embodiments described above may be implemented in software, hardware, application logic, or a combination of software, hardware, and application logic. The software, application logic, and/or hardware may reside on at least one memory, at least one processor, an apparatus or, a non-transitory computer program product. In an example embodiment, the application logic, software, or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the invention.

What is claimed is:

1. A computer-implemented method comprising a code analysis platform incorporated in a server system configured to perform the steps of:
receiving, by the server system, a written code for a coding problem from a user device submitted by a user;
performing, by the server system, an analysis of the code by running the submitted code against at least one test case that is stored for the corresponding coding problem; and
displaying, by the server system, a successful message when the submitted code seems to be working fine for all the test cases or an evaluation response when the submitted code does not clear all the test cases respectively.

2. The computer-implemented method as claimed in claim 1, is further configured to perform the steps, when the submitted code does not clear all the test cases:
performing, by the server system, fingerprint extraction of the submitted code, wherein the fingerprint extraction includes a structural code fingerprint extraction in which a structural fingerprint of the code is extracted, and a behavioral code fingerprint extraction in which a behavioral fingerprint of the code is extracted;
generating, by the server system, a formed CDNA by combining the extracted structural fingerprint and the behavioral fingerprint;
determining, by the server system one or more CDNAs stored for the corresponding coding problem of the submitted code;
comparing, by the server system, the formed CDNA with each determined CDNA to compute a similarity score for each determined CDNA; and
selecting, by the server system, one or more CDNAs from the determined CDNAs based on a predefined threshold score set for the similarity score.

3. The computer-implemented method as claimed in claim 2, further comprising:
using, by the sever system, one or more machine learning models to detect the one or more determined CDNAs whose similarity score is matching with the formed CDNA of the submitted code to determine the similar types of codes, wherein the one or more machine learning models generates the feedback for the submitted code by reusing the existing one or more feedbacks available for similar codes on the coding problem.

4. The computer-implemented method as claimed in claim 2, further comprising:
collecting, by the server system one or more feedbacks associated with the selected CDNAs; and
displaying, by the server system one or more feedbacks on the user device.

5. The computer-implemented method as claimed in claim 2, wherein the structural code fingerprint extraction comprises one of:
a cyclomatic complexity;
a number of functions; and
a number of arguments in each function of the submitted code.

6. The computer-implemented method as claimed in claim 2, wherein the behavioral code fingerprint extraction results of the testing of the code comprises one of:
a test data;
a number of tests passed;
a number of tests failed; and
an outputs of the failed tests.

7. The computer-implemented method as claimed in claim 2, wherein a similarity score value of ‘1’ means the formed CDNA of the submitted code and the determined CDNA are completely identical and the similarity score value ‘0’ means the formed CDNA of the submitted code and the determined CDNA are completely irrelevant.

8. The computer-implemented method as claimed in claim 2, further comprising:
adding, by the server system, the submitted code to a pending feedback queue when the similarity score of determined CDNAs does not meet the predefined threshold criteria.

9. The computer-implemented method as claimed in claim 7, further comprising:
sending, by the server system a notification regarding the submitted code being added in the pending feedback queue to an administrator;
facilitating, by the server system, checking the submitted code and adding a customized feedback for the submitted code indicating the problematic areas of the submitted code by the administrator;
displaying, by the server system, the customized feedback added by the administrator for the submitted code on the user device; and
storing, by the server system, the customized feedback and the formed CDNA of the submitted code in the database.

10. A server system, comprising:
a memory configured to store instructions; and
a processor configured to execute the instructions stored in the memory and thereby cause the server system to perform:
receive a written code for a coding problem from a user device submitted by a user;
perform an analysis of the code by running the submitted code against at least one test case that is stored for the corresponding coding problem; and
display a successful message when the submitted code seems to be working fine for all the test cases or an evaluation response when the submitted code does not clear all the test cases respectively.

11. The server system as claimed in claim 10 when the submitted code does not clear all the test cases, is further configured to perform the steps of:
perform fingerprint extraction of the submitted code, wherein the fingerprint extraction includes a structural code fingerprint extraction in which a structural fingerprint of the code is extracted, and a behavioral code fingerprint extraction in which a behavioral fingerprint of the code is extracted;
generate, a formed CDNA by combining the extracted structural fingerprint and the behavioral fingerprint;
determine, one or more CDNAs stored for the corresponding coding problem of the submitted code;
compare the formed CDNA with each determined CDNA to compute a similarity score for each determined CDNA; and
select, one or more CDNAs from the determined CDNAs based on a predefined threshold score set for the similarity score.

12. The server system as claimed in claim 11, wherein the server system is configured to:
use, one or more machine learning models to detect the one or more determined CDNAs whose similarity score is matching with the formed CDNA of the submitted code to determine the similar types of codes, wherein the one or more machine learning models generates the feedback for the submitted code by reusing the existing one or more feedbacks available for similar codes on the coding problem.

13. The server system as claimed in claim 11, wherein the server system is further configured to:
collect one or more feedbacks associated with the selected CDNAs; and
display one or more feedbacks on the user device.

14. The server system as claimed in claim 11, wherein the structural code fingerprint extraction comprises one of:
a cyclomatic complexity;
a number of functions; and
a number of arguments in each function of the submitted code.

15. The sever system as claimed in claim 11, wherein the behavioral code fingerprint extraction results of the testing of the code comprises one of:
a test data;
a number of tests passed;
a number of tests failed; and
an outputs of the failed tests.

16. The server system as claimed in claim 11, wherein a similarity score value of 1 means the formed CDNA of the submitted code and the determined CDNA are completely identical and the similarity score value of 0 means the formed CDNA of the submitted code and the determined CDNA are completely irrelevant.

17. The server system as claimed in claim 11, wherein the server system is further configured to:
add the submitted code to a pending feedback queue when the similarity score of determined CDNAs does not meet the predefined threshold criteria.

18. The server system as claimed in claim 17, wherein the server system is further configured to:
send a notification regarding the submitted code being added to the pending feedback queue to an administrator;
facilitate checking the submitted code and add a customized feedback for the submitted code indicating the problematic areas of the submitted code by the administrator;
display the customized feedback added by the administrator for the submitted code on the user device; and
store the customized feedback and the formed CDNA of the submitted code in the database.

19. A system comprising:
a memory configured to store instructions;
a communication interface; and
a processor in communication with the memory and the communication interface, the processor configured to execute the instructions stored in the memory and further comprising:
a fingerprint extraction module configured to extract one or more structural and behavioral fingerprints of a submitted code for creating at least one formed CDNA associated with the submitted code of the user,
a similarity score computation module configured to determine one or more CDNAs stored for the corresponding coding problem and generate a score list describing each determined CDNA with their calculated similarity score by computing a similarity score between each determined CDNAs and the formed CDNA associated with the submitted code,
a feedback selection module configured to select one or more feedbacks from a plurality of feedbacks stored for the at least one determined CDNAs whose similarity score is found to be greater than the predefined threshold score or add the submitted code to a pending feedback queue when the similarity score of determined CDNAs does not meet the predefined threshold criteria, and
a notification management module configured to control the notification messages that are to be sent to a user and an administrator sent to the user device and administrator device respectively.

20. The system as claimed in claim 19, wherein the notification management module is further configured to:
send a notification message to the administrator device to inform the administrator about the addition of the code in the feedback pending queue; and
send a notification on the user device to inform the user about the availability of the feedback for the submitted code.
